(19) United States
(12) Patent Application Publication
(10) Pub. No.: US 2023/0259791 A1
(43) Pub. Date: Aug. 17, 2023

(54) METHOD AND SYSTEM TO TRANSFER LEARNING FROM ONE MACHINE TO ANOTHER MACHINE

(71) Applicant: INTERNATIONAL BUSINESS MACHINES CORPORATION, ARMONK, NY (US)

(72) Inventors: Partho Ghosh, Kolkata (IN); Shailendra Moyal, Pune (IN); Sarbajit K. Rakshit, Kolkata (IN)

(21) Appl. No.: 17/651,079

(22) Filed: Feb. 15, 2022

(51) Int. Cl. G06N 5/02

(52) U.S. Cl. CPC G06N 5/022; G06N 20/00

(57) ABSTRACT

A computer-implemented method for transferring a knowledge corpus from a first machine to a second machine. The method compares a digital twin model of the first machine with the second machine and identifies whether the knowledge corpus transfer is possible, based on the comparison. If the knowledge corpus transfer is possible, the method maps the knowledge corpus of the first machine with input and output systems of the second machine. If the knowledge corpus transfer is not possible, the method identifies how functionalities of the first machine and the second machine are being executed and controlled. The method then creates a hierarchical functional digital twin model of the first machine and the second machine, based on the identified functionalities. The method further transfers the mapped knowledge corpus of the first machine with the input and output systems of the second machine.

### BACKGROUND

The present disclosure relates generally to the field of cognitive computing and more particularly to data processing and dynamic learning between one or more machines.

Nowadays, machines (e.g., autonomous vehicles) or devices can gather data from their surroundings, analyze the data, and make decisions based on the analyzed data.

However, the way one machine collects information may not be the same for other machines. As such, direct transfer of a knowledge corpus from one machine to another machine may not be directly applicable.

### SUMMARY

Embodiments of the present invention disclose a method, a computer program product, and a system.

A method, according to an embodiment of the invention, in a data processing system including a processor and a memory. The method includes comparing a digital twin model of the first machine with the second machine. The method further includes identifying whether the knowledge corpus transfer is possible based on the comparison, and if the knowledge corpus transfer is possible, mapping the knowledge corpus of the first machine with input and output systems of the second machine. The method further includes transferring the mapped knowledge corpus of the first machine with the input and output systems of the second machine.

A computer program product, according to an embodiment of the invention, includes a non-transitory tangible storage device having program code embodied therewith. The program code is executable by a processor of a computer to perform a method. The method includes comparing a digital twin model of the first machine with the second machine. The method further includes identifying whether the knowledge corpus transfer is possible based on the comparison, and if the knowledge corpus transfer is possible, mapping the knowledge corpus of the first machine with input and output systems of the second machine. The method further includes transferring the mapped knowledge corpus of the first machine with the input and output systems of the second machine.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method includes comparing a digital twin model of the first machine with the second machine. The method further includes identifying whether the knowledge corpus transfer is possible based on the comparison, and if the knowledge corpus transfer is possible, mapping the knowledge corpus of the first machine with input and output systems of the second machine. The method further includes transferring the mapped knowledge corpus of the first machine with the input and output systems of the second machine.

### BRIEF DESCRIPTION OF THE DRAWINGS

FIG. 1 illustrates a learning transfer computing environment, in accordance with an embodiment of the present disclosure.

FIG. 2 is a flowchart illustrating the operation of learning transfer program 120 of FIG. 1, in accordance with an embodiment of the present disclosure.

FIG. 3 is a diagram graphically illustrating the hardware components of learning transfer computing environment of FIG. 1, in accordance with an embodiment of the present disclosure.

FIG. 4 depicts a cloud computing environment, in accordance with an embodiment of the present disclosure.

FIG. 5 depicts abstraction model layers of the illustrative cloud computing environment of FIG. 4, in accordance with an embodiment of the present disclosure.

### DETAILED DESCRIPTION

The present disclosure discloses a method that can transfer learning from one machine (e.g., vehicles, such as autonomous vehicles) to another machine.

Different machines can have different functionalities, different input collection mechanisms, different control systems, and so forth. Similarly, the way one machine collects information may not be the same for other machines, or the way one machine makes decisions may not be the same for other machines. As such, the direct transfer of a knowledge corpus from one machine to another machine may not be directly applicable.

The present disclosure details a method and a system by which learning from one machine can be transferred to another machine, even if the two machines are dissimilar.

For example, while any machine or device is being used, it may perform self-learning. Self-learning includes gathering data from its surroundings, analyzing the gathered data, and taking appropriate action. In the case of autonomous vehicles, the autonomous vehicle is creating a knowledge corpus based on its self-learning. Different data collection modules of the vehicle gather data and use same to build its knowledge corpus.

Since different vehicles have different functionalities, they will invariably have different input collection mechanisms, different control systems, and so forth. Similarly, direct transfer of a knowledge corpus of one vehicle to another vehicle may not be directly applicable.

The present disclosure describes a method and a system by which learning from one machine (e.g., vehicle) can be transferred to another machine.

Hereinafter, exemplary embodiments of the present disclosure will be described in detail with reference to the attached drawings.

The present disclosure is not limited to the exemplary embodiments below but may be implemented with various modifications within the scope of the present disclosure. In addition, the drawings used herein are for purposes of illustration, and may not show actual dimensions.

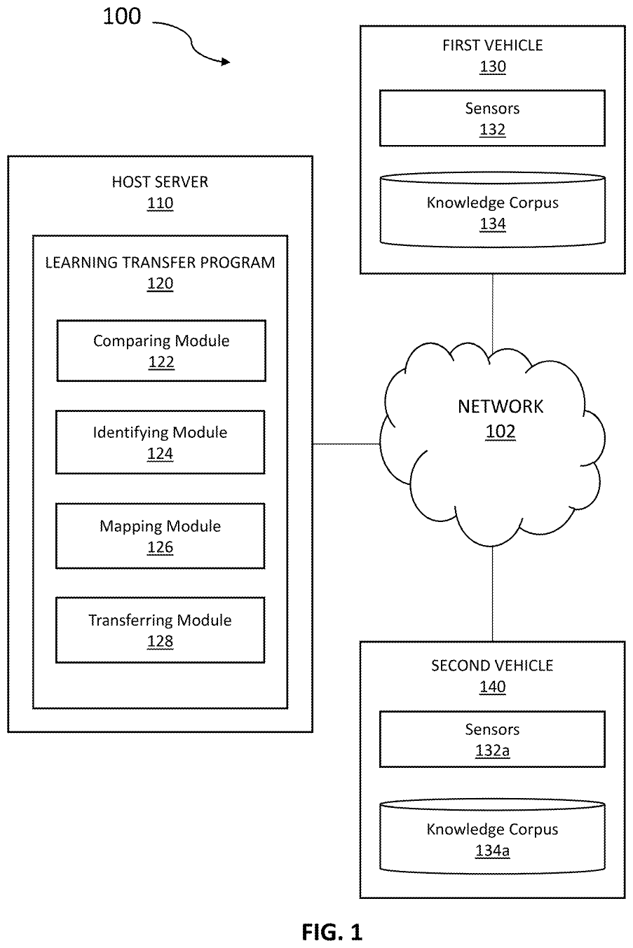

FIG. 1 illustrates learning transfer computing environment 100, in accordance with an embodiment of the present disclosure. Learning transfer computing environment 100 includes host server 110, first vehicle 130, and second vehicle 140 all connected via network 102. The setup in FIG. 1 represents an example embodiment configuration for the present disclosure and is not limited to the depicted setup to derive benefit from the present disclosure.

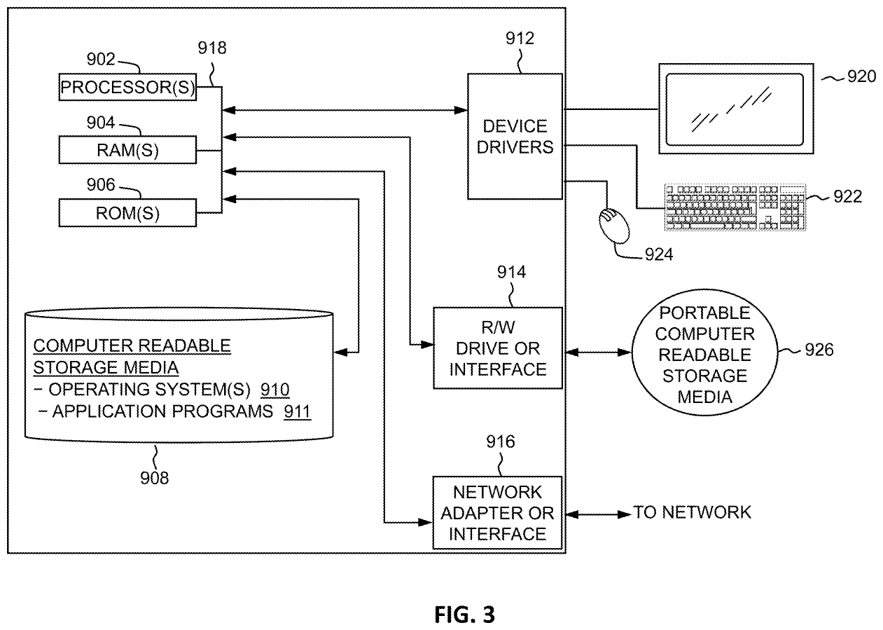

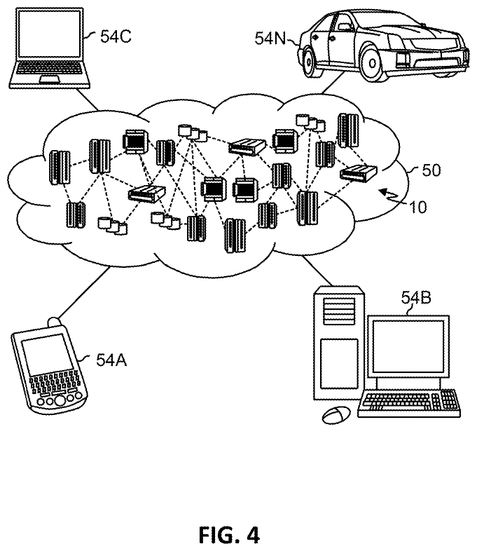

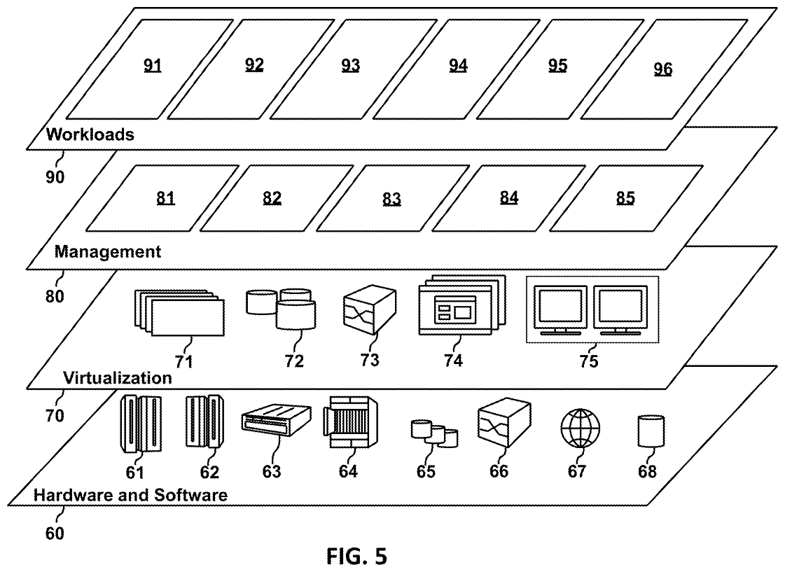

In an exemplary embodiment, host server 110 includes learning transfer program 120. In various embodiments, host server 110 may be a laptop computer, tablet computer, netbook computer, personal computer (PC), a desktop computer, a personal digital assistant (PDA), a smart phone, a server, or any programmable electronic device capable of communicating with first vehicle 130 and second vehicle 140 via network 102. Host server 110 may include internal and external hardware components, as depicted and described in further detail below with reference to FIG. 3. In other embodiments, host server 110 may be implemented in a cloud computing environment, as described in relation to FIGS. 4 and 5, herein. Host server 110 may also have wireless connectivity capabilities allowing the host server 110 to communicate with first vehicle 130, second vehicle 140, and other computers or servers over network 102.

With continued reference to FIG. 1, first vehicle 130 includes sensors 132 and knowledge corpus 134. In exemplary embodiments, first vehicle 130 may include, but is not limited to, a car, a minivan, a truck, a tractor-trailer, a train, or any road vehicle. In alternative embodiments, first vehicle 130 may be a vehicle that flies in the sky (e.g., airplane, rocket ship, hot-air balloon, hovercraft, etc.), a vehicle that floats on the water (e.g., motorboat, yacht, jet ski, pontoon, freight ship, etc.), and any other vehicle known to one of ordinary skill in the art.

In exemplary embodiments, first vehicle 130 includes one or more sensors 132 (same as sensors 132a in relation to second vehicle 140).

Sensors 132 may be a device, hardware component, module, or subsystem capable of recording, capturing, and detecting events or changes in a user environment, or proximity, and sending the detected data to other electronics (e.g., host server 110), components (e.g., knowledge corpus 134), or programs (e.g., learning transfer program 120) within a system such as learning transfer computing environment 100. In various embodiments, the detected data collected by sensors 132 are instrumental in creating a knowledge corpus 134 of functionality for first vehicle 130 and second vehicle 140, respectively.

Sensors 132, in exemplary embodiments, are located within first vehicle 130, and second vehicle 140, and may be a global positioning system (GPS), software application, proximity sensor, camera, microphone, light sensor, infrared sensor, weight sensor, temperature sensor, tactile sensor, motion detector, optical character recognition (OCR) sensor, occupancy sensor, heat sensor, analog sensor (e.g., potentiometers, force-sensing resistors), radar, radio frequency sensor, quick response (QR) code, video camera, digital camera, Internet of Things (IoT) sensors, lasers, gyroscopes, accelerometers, actuators, structured light systems, user tracking sensors (e.g., eye, head, hand, and body tracking positions of a user), and other devices used for measuring, detecting, and recording input and output of the various systems associated with first vehicle 130 and second vehicle 140.

In exemplary embodiments, sensors 132 are capable of continuously monitoring, collecting, and saving collected data on a local storage, such as knowledge corpus 134, or sending the collected data to learning transfer program 120. In alternative embodiments, sensors 132 may be capable of detecting, communicating, pairing, or syncing with internet of things (IoT) devices, thus creating opportunities for more direct integration of the physical world into computer-based systems, and resulting in improved efficiency, accuracy, and economic benefit in addition to reduced human intervention.

In various embodiments, sensors 132 are embedded within various systems associated with the first vehicle 130 and/or second vehicle 140 (e.g., lighting system, engine, steering, safety, etc.) that contain a computer processing unit (CPU), memory, and power resource, and may be capable of communicating with first vehicle 130, second vehicle 140, and host server 110 over network 102. In this fashion, functionality of the various systems of first vehicle 130, and second vehicle 140, can be obtained by one or more inputs of data collection of sensors 132.

In exemplary embodiments, learning transfer program 120 may identify how different functionalities are executed by different sensor participation (i.e., sensors 132) and what types of functionalities are present.

In exemplary embodiments, knowledge corpus 134 may be local data storage on first vehicle 130 that contains one or more sets of learning data. Learning data may include data sets comprising gathered data from the machine's surroundings and machine functionality, analyzed data from the machine's surroundings and machine functionality, decision data based on the analyzed data, and self-learning data based on the decision data. For example, sensors 132 continually collect data from various sensor systems associated with first vehicle 130, and may be organized according to functionality (e.g., lighting system, engine, steering, safety, etc.).

While knowledge corpus 134 is depicted as being stored on first vehicle 130, and second vehicle 140), in other embodiments, knowledge corpus 134 may be stored on host server 110, learning transfer program 120, or any other device or database connected via network 102, as a separate database. In alternative embodiments, knowledge corpus 136 may be comprised of a cluster or plurality of computing devices, working together, or working separately.

In exemplary embodiments, second vehicle 140 may include the same, or similar components as first vehicle 130, such as sensors 132a and knowledge corpus 134a. In exemplary embodiments second vehicle 140 may be capable of communicating with first vehicle 130 via vehicle-to-vehicle (V2V) communication, Wireless Fidelity (WiFi), and Radio Frequency Identification (RFID), or by any other means known to one of ordinary skill in the art.

With continued reference to FIG. 1, learning transfer program 120, in an exemplary embodiment, may be a computer application on host server 110 that contains instruction sets, executable by a processor. The instruction sets may be described using a set of functional modules. In exemplary embodiments, learning transfer program 120 may receive input from first vehicle 130 and second vehicle 140 over network 102. In alternative embodiments, learning transfer program 120 may be a computer application contained within first vehicle 130, or a standalone program on a separate electronic device.

With continued reference to FIG. 1, the functional modules of learning transfer program 120 include comparing module 122, identifying module 124, mapping module 126, and transferring module 128.

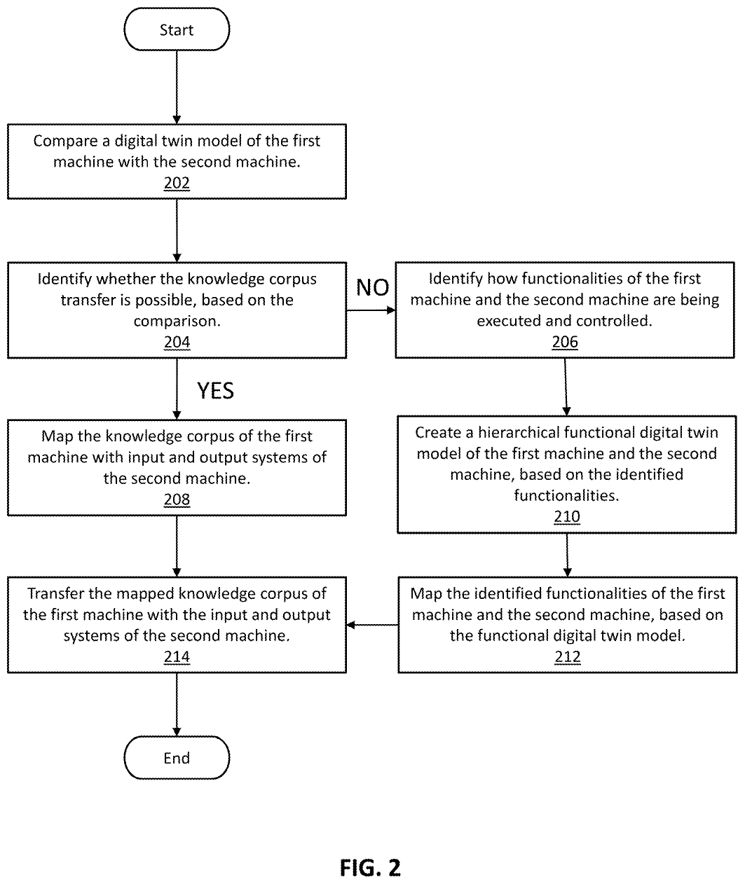

FIG. 2 is a flowchart illustrating the operation of learning transfer program 120 of FIG. 1, in accordance with embodiments of the present disclosure.

With reference to FIGS. 1 and 2, comparing module 122 includes a set of programming instructions in learning transfer program 120, to compare a digital twin model of the first machine with the second machine (step 202). The set of programming instructions is executable by a processor.

A digital twin is a virtual model designed to accurately reflect a physical object. The object being studied (e.g., vehicle) is outfitted with various sensors (e.g., sensors 132) related to vital areas of functionality. These sensors 132 produce data about different aspects of the physical object's performance, such as energy output, engine efficiency, steering effectiveness, safety performance, and more. This data is then relayed to a processing system and applied to the digital copy.

Once informed with such data, the virtual digital twin model can be used to run simulations, study performance issues, and generate possible improvements, all with the goal of generating valuable insights which can then be applied back to the original physical object.

By having better and constantly updated data related to a wide range of areas, combined with the added computing power that accompanies a virtual environment, digital twins can study more issues from far more vantage points than standard simulations can, with greater ultimate potential to improve products and processes.

In exemplary embodiments, each vehicle (e.g., first vehicle 130) is identified uniquely, and each vehicle has its own digital twin model. Comparing module 122, in exemplary embodiments, compares the digital twin model of the sending (i.e., first vehicle 130) and receiving (i.e., second vehicle 140) vehicles.

With reference to an illustrative example, comparing module 122 compares the digital twin model of first vehicle 130 (e.g., the sending vehicle) with second vehicle 140 (e.g., the receiving vehicle). First vehicle 130 is a BMW SUV. Second vehicle 140 is a BMW sedan. In a parallel illustrative example, first vehicle 130 is a BMW SUV and second vehicle 140 is a semi-trailer truck. In both illustrative examples, comparing module 122 compares the similarities and differences between the various sensor systems (i.e., sensors 132) associated with the sending vehicle (e.g., BMW SUV) and the receiving vehicle (e.g., BMW sedan and semi-trailer truck).

With continued reference to FIGS. 1 and 2, identifying module 124 includes a set of programming instructions in learning transfer program 120, to identify whether the knowledge corpus transfer is possible, based on the comparison (step 204). The set of programming instructions are executable by a processor.

In exemplary embodiments, the digital twin model identifies each sensor feed of a first vehicle 130 and creates its digital twin. For example, one functionality of first vehicle 130 is completed by one or more collections of sensor 132 inputs. Such functionality includes, but is not limited to, head light functionality, air-conditioning functionality, etc.

Identifying module 124 identifies how different functionalities are executed by different sensor 132 participation, what type of functionalities are present, and how different functionalities can be grouped together in the vehicle's digital twin.

In exemplary embodiments, first vehicle 130's knowledge corpus 134 is created based on the identified functionalities of the sending vehicle (i.e., the first vehicle 130). Identifying module 124, as detailed above, then identifies whether the knowledge corpus 134 transfer is possible, based on the comparison of the first vehicle 130 (e.g., sending vehicle) and the second vehicle 140 (e.g., receiving vehicle), in a one-to-one comparison of functionality.

With continued reference to FIGS. 1 and 2, if the knowledge corpus 134 transfer is not possible, identifying module 124 identifies how functionalities of the first machine (i.e., first vehicle 130) and the second machine (i.e., second vehicle 140) are being executed and controlled (step 206).

With continued reference to the illustrative example above, identifying module 124 identifies that a one-to-one knowledge corpus 134 transfer from the BMW SUV to the BMW sedan is possible because the digital twin model of the sending vehicle (i.e., BMW SUV) and receiving vehicle (i.e., BMW sedan) are almost identical. However, a one-to-one knowledge corpus 134 transfer from the BMW SUV to the semi-trailer truck is not possible because the various input and output sensors 132 are different from the sending vehicle to the receiving vehicle, so one-to-one mapping is not possible.

With continued reference to FIGS. 1 and 2, mapping module 126 includes a set of programming instructions in learning transfer program 120, to map the knowledge corpus 134 of the first machine (e.g., first vehicle 130) with input and output systems of the second machine (e.g., second vehicle 140) (step 208). The set of programming instructions is executable by a processor.

In exemplary embodiments, one-to-one mapping is possible if the vehicles have the same configuration, input collection systems, and so forth. As such, the knowledge corpus 134 is transferred and mapped, via mapping module 126, from first vehicle 130 to second vehicle 140 with the required functionalities.

With continued reference to FIGS. 1 and 2, if one-to-one mapping is not possible, learning transfer program 120 creates a hierarchical functional digital twin model of the first machine (e.g., first vehicle 130) and the second machine (e.g., second vehicle 140), based on the identified functionalities (step 210).

With continued reference to FIGS. 1 and 2, mapping module 126 maps the identified functionalities of the first machine and the second machine, based on the functional digital twin model (step 212).

In exemplary embodiments, a hierarchical digital twin model is created by grouping the functionalities of the first machine and the second machine in a hierarchical fashion and identifying which hierarchical level the knowledge corpus 134 of the first machine can be mapped with the second machine.

In further exemplary embodiments, learning transfer program 120 identifies how different functionalities of the received knowledge corpus 134 of the first machine are mapped with functionality of the second machine and adapts the received knowledge corpus 134 of the first machine (e.g., first vehicle 130) with the input and output systems of the second machine (second vehicle 140).

In alternative embodiments, mapping module 126 can create mapping metrics between the first machine and the second machine, based on the identified knowledge corpus 134. If there is a gap in functionality between the first machine and the second machine, learning transfer program 120 can identify collaboration with one or more other devices to improve on the knowledge corpus 134 with a function and feature of the one or more other devices.

In further alternative embodiments, learning transfer program 120 can automatically adapt the hierarchical functional twin model of the first machine (i.e., first vehicle 130) and the second machine (i.e., second vehicle 140), based on the identified collaboration with the one or more other devices.

In alternative embodiments, learning transfer program 120 can create a mesh network of the one or more other devices and determine a best sender device, from the mesh network, of the one or more other devices. Learning transfer program 120 can transfer a complete mapping, inclusive of the gap in functionality learned from the collaboration with the one or more other devices, to the second machine (i.e., second vehicle 140).

Referring back to the illustrative example above, mapping module 126 maps the one-to-one knowledge corpus 134 of the BMW SUV with the input and output systems of the BMW sedan. With regards to the mapping of the knowledge corpus from the BMW SUV to the semi-trailer truck, mapping module 126 maps the identified functionalities of the BMW SUV with the semi-trailer truck, based on the created hierarchical functional digital twin model. Mapping module 126 then identifies how much one-to-one knowledge corpus 134 transfer is possible between the BMW SUV and the semi-trailer truck and how much functional digital twin-based knowledge corpus transfer is possible.

With continued reference to FIGS. 1 and 2, transferring module 128 includes a set of programming instructions in learning transfer program 120, to transfer the mapped knowledge corpus of the first machine with the input and output systems of the second machine (step 214). The set of programming instructions is executable by a processor.

In exemplary embodiments, transferring module 128 transfers the knowledge corpus 134 from first vehicle 130, together with its mapped functionalities so that the second vehicle 140 (i.e., receiving vehicle) can receive the knowledge corpus 134.

In alternative embodiments, while transferring module 128 transfers the knowledge corpus 134 from sending vehicle to receiving vehicle, learning transfer program 120 identifies the best possible combination of knowledge corpus 134 transfer (e.g., one-to-one knowledge corpus versus functionality-based knowledge corpus transfer).

With continued reference to the illustrative example above, transferring module 128 performs a one-to-one knowledge corpus 134 transfer from the BMW SUV to the BMW sedan since the digital twin model of the sending vehicle and the receiving vehicle are almost the same. Transferring module 128 performs a functionality-based knowledge corpus 134 transfer from the BMW SUV to the semi-trailer truck because the various input and output sensors are different from the sending vehicle and the receiving vehicle. As such, learning transfer program 120 is comparing different levels of functionality in the digital twin models of the respective vehicles.

In exemplary embodiments, network 102 is a communication channel capable of transferring data between connected devices and may be a telecommunications network used to facilitate telephone calls between two or more parties comprising a landline network, a wireless network, a closed network, a satellite network, or any combination thereof. In another embodiment, network 102 may be the Internet, representing a worldwide collection of networks and gateways to support communications between devices connected to the Internet. In this other embodiment, network 102 may include, for example, wired, wireless, or fiber optic connections which may be implemented as an intranet network, a local area network (LAN), a wide area network (WAN), or any combination thereof. In further embodiments, network 102 may be a Bluetooth® network, a WiFi network, a vehicle-to-vehicle (V2V) network, a vehicle-to-infrastructure (V2I) network, a peer-to-peer (P2P) communication network, a mesh network, or a combination thereof. In general, network 102 can be any combination of connections and protocols that will support communications between host server 110, first vehicle 130, and second vehicle 140.

FIG. 3 is a block diagram depicting components of a computing device (such as host server 110, as shown in FIG. 1), in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Computing device of FIG. 3 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as learning transfer program 120, may be stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device of FIG. 3 may also include a R/W drive or interface 914 to read from and write to one or more portable computer readable storage media 926. Application programs 911 on computing device of FIG. 3 may be stored on one or more of the portable computer readable storage media 926, read via the respective RAY drive or interface 914 and loaded into the respective computer readable storage media 908.

Computing device of FIG. 3 may also include a network adapter or interface 916, such as a TCP/IP adapter card or wireless communication adapter (such as a 4G wireless communication adapter using OFDMA technology). Application programs 911 on computing device of FIG. 3 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Computing device of FIG. 3 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and controlling access to data objects 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications and substitutions can be made without deviating from the scope of the present invention. Therefore, the present invention has been disclosed by way of example and not limitation.

What is claimed is:

1. A computer-implemented method for transferring a knowledge corpus from a first machine to a second machine, comprising:
comparing a digital twin model of the first machine with the second machine;
identifying whether the knowledge corpus transfer is possible, based on the comparison;
if the knowledge corpus transfer is possible, mapping the knowledge corpus of the first machine with input and output systems of the second machine; and
transferring the mapped knowledge corpus of the first machine with the input and output systems of the second machine.

2. The computer-implemented method of claim 1, further comprising:
if the knowledge corpus transfer is not possible, identifying how functionalities of the first machine and the second machine are being executed and controlled;
creating a hierarchical functional digital twin model of the first machine and the second machine, based on the identified functionalities;
mapping the identified functionalities of the first machine and the second machine, based on the functional digital twin model; and
receiving, by the second machine, the knowledge corpus of the first machine.

3. The computer-implemented method of claim 2, wherein the hierarchical functional digital twin model is created by:
grouping the functionalities of the first machine and the second machine in a hierarchical fashion; and
identifying which hierarchical level the knowledge corpus of the first machine can be mapped with the second machine.

4. The computer-implemented method of claim 3, further comprising:
identifying, by the second machine, how different functionalities of the received knowledge corpus of the first machine are mapped with functionality of the second machine; and
adapting, by the second machine, the received knowledge corpus of the first machine with the input and output systems of the second machine.

5. The computer-implemented method of claim 3, further comprising:
creating mapping metrics between the first machine and the second machine, based on the identified knowledge corpus; and
if there is a gap in functionality between the first machine and the second machine, identifying, by the first machine, collaboration with one or more other devices to improve on the knowledge corpus with a function and feature of the one or more other devices.

6. The computer-implemented method of claim 5, further comprising:
automatically adapting the hierarchical functional twin model of the first machine and the second machine, based on the identified collaboration with the one or more other devices.

7. The computer-implemented method of claim 5, further comprising:
creating a mesh network of the one or more other devices;
determining a best sender device from the mesh network of the one or more other devices; and
transferring a complete mapping, inclusive of the gap in functionality learned from the collaboration with the one or more other devices, to the second machine.

8. A computer program product, comprising a non-transitory tangible storage device having program code embodied therewith, the program code executable by a processor of a computer to perform a method, the method comprising:
comparing a digital twin model of the first machine with the second machine;
identifying whether the knowledge corpus transfer is possible, based on the comparison;
if the knowledge corpus transfer is possible, mapping the knowledge corpus of the first machine with input and output systems of the second machine; and
transferring the mapped knowledge corpus of the first machine with the input and output systems of the second machine.

9. The computer program product of claim 8, further comprising:
if the knowledge corpus transfer is not possible, identifying how functionalities of the first machine and the second machine are being executed and controlled;
creating a hierarchical functional digital twin model of the first machine and the second machine, based on the identified functionalities;
mapping the identified functionalities of the first machine and the second machine, based on the functional digital twin model; and
receiving, by the second machine, the knowledge corpus of the first machine.

10. The computer program product of claim 9, wherein the hierarchical functional digital twin model is created by:
grouping the functionalities of the first machine and the second machine in a hierarchical fashion;
identifying which hierarchical level the knowledge corpus of the first machine can be mapped with the second machine.

11. The computer program product of claim 10, further comprising:
identifying, by the second machine, how different functionalities of the received knowledge corpus of the first machine are mapped with functionality of the second machine; and
adapting, by the second machine, the received knowledge corpus of the first machine with the input and output systems of the second machine.

12. The computer program product of claim 10, further comprising:
creating mapping metrics between the first machine and the second machine, based on the identified knowledge corpus; and
if there is a gap in functionality between the first machine and the second machine, identifying, by the first machine, collaboration with one or more other devices to improve on the knowledge corpus with a function and feature of the one or more other devices.

13. The computer program product of claim 12, further comprising:
automatically adapting the hierarchical functional twin model of the first machine and the second machine, based on the identified collaboration with the one or more other devices.

14. The computer program product of claim 12, further comprising:
creating a mesh network of the one or more other devices;
determining a best sender device from the mesh network of the one or more other devices; and
transferring a complete mapping, inclusive of the gap in functionality learned from the collaboration with the one or more other devices, to the second machine.

15. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
comparing a digital twin model of the first machine with the second machine;
identifying whether the knowledge corpus transfer is possible, based on the comparison;
if the knowledge corpus transfer is possible, mapping the knowledge corpus of the first machine with input and output systems of the second machine; and
transferring the mapped knowledge corpus of the first machine with the input and output systems of the second machine.

16. The computer system of claim 15, further comprising:
if the knowledge corpus transfer is not possible, identifying how functionalities of the first machine and the second machine are being executed and controlled;
creating a hierarchical functional digital twin model of the first machine and the second machine, based on the identified functionalities;
mapping the identified functionalities of the first machine and the second machine, based on the functional digital twin model; and
receiving, by the second machine, the knowledge corpus of the first machine.

17. The computer system of claim 16, wherein the hierarchical functional digital twin model is created by:
grouping the functionalities of the first machine and the second machine in a hierarchical fashion;
identifying which hierarchical level the knowledge corpus of the first machine can be mapped with the second machine.

18. The computer system of claim 17, further comprising:
identifying, by the second machine, how different functionalities of the received knowledge corpus of the first machine are mapped with functionality of the second machine; and
adapting, by the second machine, the received knowledge corpus of the first machine with the input and output systems of the second machine.

19. The computer system of claim 17, further comprising:
creating mapping metrics between the first machine and the second machine, based on the identified knowledge corpus; and
if there is a gap in functionality between the first machine and the second machine, identifying, by the first machine, collaboration with one or more other devices to improve on the knowledge corpus with a function and feature of the one or more other devices.

20. The computer system of claim 19, further comprising:
automatically adapting the hierarchical functional twin model of the first machine and the second machine, based on the identified collaboration with the one or more other devices.
